(19) United States
(12) Patent Application Publication
(10) Pub. No.: US 2019/0392178 A1
(43) Pub. Date: Dec. 26, 2019

(54) Method and System for Monitoring a Smart Contract on a Distributed Ledger

(71) Applicant: Bootstrap Legal Inc., Los Angeles, CA (US)

(72) Inventor: dan rice, Los Angeles, CA (US)

(73) Assignee: Bootstrap Legal Inc., Los Angeles, CA (US)

(21) Appl. No.: 16/019,203

(22) Filed: Jun. 26, 2018

(51) Int. Cl. G06F 21/64; H04L 12/26; H04L 9/06

(52) U.S. Cl. CPC G06F 21/64; H04L 9/0637; H04L 43/06; H04L 43/12

(57) ABSTRACT

The invention relates to a system and method for creating and managing smart contracts on a blockchain. More specifically, the invention relates to a method and system that provides a set of tools for users to create, monitor, manage, modify, terminate, trigger disputes, communicate with contracting parties, and if necessary resolve a dispute over a smart contract. Additionally, the invention provides a server that monitors activity on a distributed ledger and reports it to interested parties so that they can take appropriate action such as authorize, freeze, dispute, ro communicate regarding the smart contract.

This application hereby references and incorporates concurrently filed non-provisional U.S. patent application Nos. ______ and ______.

### BACKGROUND OF INVENTION

### Field of Invention

The invention relates to a system and method, for creating and managing smart contracts on a blockchain. More specifically, the invention relates to a method and system that provides a set of tools for users to create, monitor, manage, modify, terminate, trigger disputes, communicate with contracting parties, and if necessary resolve a dispute over a smart contract.

### Background of the Invention

In recent years, cryptocurrency and blockchain systems have grown in popularity with the introduction of smart contracts. The benefit of smart contracts is that they are programmed in code and will automatically execute. This takes the uncertainty out of many transactions and can potentially eliminate the need for costly middlemen. However, at the same time the self-executing nature of smart contracts makes errors in smart contract extremely costly. Once a transaction has been executed by a smart contract on a blockchain, it is extremely difficult, if not impossible, to reverse. However, despite the increased activity within the space, smart contracts are still very rudimentary and prone to error. In 2017 alone, over $1 billion USD was lost due to smart contract errors. Smart contracts are currently being programed at a very basic level and all necessary functionality must be programmed.

The problem is further complicated when using smart contracts on a blockchain, Blockchain systems have many benefits that make them very useful, however some of these characteristics also present challenges. One benefit of many blockchain systems is that they are immutable and permanent (some have varying levels of immutability). While this is extremely useful for creating a trustless ledger, this feature makes it difficult to use smart contracts on a blockchain because contracts often need to be amended, terminated, or disputed prior to their execution. Additionally, the permanence of a transaction further heightens the need for tools to amend, terminate, or dispute a smart contract prior to its execution. Furthermore, blockchains are closed systems that have very little to no interaction with the outside world; thus, there currently does not exist any way of efficiently monitoring the activity of a smart contract stored on a blockchain. Lastly, most blockchains are pseudo-anonymous and parties are only identified using an address; thus, there is no easy way to communicate with other parties on a blockchain regarding a smart contract.

Accordingly there exists a need for a system and method of creating, monitoring, managing control and access to smart contract, modify, terminate, trigger disputes, communicate with contracting parties, and resolve disputes within a smart contract.

### SUMMARY OF INVENTION

The present invention is described in an embodiment for implementing smart contracts on a blockchain. However, a person of ordinary skill in the art would understand and recognize that the features of the present invention could also be used in a plurality of other systems including distributed ledgers, directed acyclic graph (DAGs), centralized systems, and various different types of blockchains (public or private) or hybrid systems.

### Contract Creation

First, the invention provides a graphical user interface (GUI) that allows the contracting parties to create a smart contract, set access and permissions, negotiate contract terms, set escrow amount, and set a preferred dispute resolution vendor. While the disclosure is directed towards a purchase contract with escrow, it should be understood that additional contract functionality could be implemented such as: purchase goods or services, betting or wager, and electronic wire of funds. Additionally, the present invention also allows users to program their own smart contracts.

Second, the present invention provides for a GUI that allows users to manage their smart contracts between active and archived contracts. Active contracts are contracts that have not been signed and archived contracts are contracts that have been signed. The GUI provides information on each contract including but not limited to contract ID, date, contracting parties, last updated, and status.

Third, the present invention provides for a GUI that allows users to negotiate and propose revisions to an active contract. The system records all revisions and comments during the contracting phase. The parties may optionally choose to include notes and revisions as part of their final contract. In one embodiment the GUI is implemented as a website provided by a central server. In alternative embodiments the GUI is implemented as a DApp provided by a decentralized server. Further still, the system can be embodied in downloadable software or mobile applications. Lastly, the invention can be implemented as an API to work with other applications.

Fourth, the present invention provides an escrow feature to hold the funds in the smart contract. The system provides for a frictionless escrow system which accepts fiat currency from one user and converts it to cryptocurrency to be held in the smart contract. The smart contract can further be programmed to receive external input to trigger the execution of the smart contract such as for purchase of goods, the smart contract may accept delivery confirmation information from a postal carrier. Alternatively, for sports betting contracts, the smart contract could be programmed to receive external input from official sports feeds to automatically pay based on the outcome of a sporting event. Indeed, any type of external data feed may be used to trigger the execution of a smart contract. It may be preferable to use multiple different feeds if possible, for confirmation and redundancy. Additionally, the contracting parties could also be required to confirm the execution of a contract once a feed result is received.

Once the smart contract is compiled, the system records it on the blockchain and reference the historical documents such as prior versions, proposed edits, and/or messages. The smart contract of the present invention comprises at least the following features;
a hash—function that maps data of arbitrary size to data of a fixed size, this could include hash, of prior versions of a contract or other reference documents pertaining to the contract that the parties wish to link with the contract;
state—governance list, current status of contract (whether it is frozen or not), language, governance control parameters, dispute resolution vendor, whether self resolution is enabled or not, delayed transaction records, contract specific dispute resolution workflow (which could vary from contract to contract), contract upgrade proxy address, freeze mode toggle;
executable code—software code that can be run by the computer;
logs/events—signals that smart contracts can fire which can be received by external applications that have configured listeners;
public entry points/external access points—code points at which control is passed to the program from an external source;
SDK—will be discussed in greater detail below. In sum, it comprises code for managing governance, freezing contract, triggering a dispute, dispute resolution self help, and dispute resolution/arbitration platform.

The smart contract may be stored based on the type of blockchain that is used. In one embodiment, the smart contract would be separately and independently recorded from the SDK functionality. The system would implement a proxy to call the smart contract. This feature allows for the smart contract to be subsequently modified by changing the proxy call address to the address of the new modified smart contract. There are numerous benefits from allowing a smart contract to be amended in a blockchain. It allows for bugs and errors to be caught and fixed without major interruption to the service. Additionally, it allows for parties to be able to quickly and efficiently amend or modify smart contracts. Furthermore, modifiable smart contracts also solves the problem of frozen assets. Frozen assets can be reconciled/returned by creating new contract with coin ownership list stored as part of state information. Thus, the new contract can seamlessly replace the old contract without additional burden or hassle.

Alternatively, in another embodiment, the smart contract and SDK, can be recorded together. In this embodiment, the smart contract freeze function is programmed as an if/then statement to check the smart contract's “state” as either DRModetrue or DRModefalse. If the DRMode is true, then the contract state is frozen and contract cannot execute until the state is changed. The benefit of this feature is that it minimizes on transaction costs if the blockchain requires payment for using proxy calls. When frozen, the executable code cannot be modified, but by using a call proxy admin function, any code held in another published contract can be called and executed in the context of the contract allowing a wide range of changes to state and value held in the contract.

### Contract Management

The subject of this invention comprises a system and method for monitoring smart contract activity, managing control and access to smart contract, modify, terminate, trigger disputes, communicate with contracting parties, and resolve disputes.

Regarding monitoring of smart contract activity, the invention employs a program stored in a centralized cloud server that passively listens to activity reported from a blockchain node for activity related to a list of smart contracts of interest stored on the server. The, program determines whether the activity is of interest using a plurality of filters including but not limited to: smart contract address, partial hash of public function of a smart contract, application binary interface (ABI), transaction header, and/or setting threshold values for transaction information, contract state changes, code patterns, transaction patterns, external contract interactions, log messages, and SDK triggers. These filters may be programed in many combinations with each other based on the desired interest of the party monitoring the smart contract. Additionally/alternatively, the system may also filter purely based on set parameters.

Next, the program notifies interested parties when a transaction of interest is about to execute. Transaction information provided by a blockchain is often unreadable and contains additional information that may be confusing to readers. Accordingly, the program extracts relevant information and generates a readable message to send to the interested parties. In some embodiments the program notifies interested parties after the execution of certain code.

The invention further employs a software development kit (SDK) that provides tools for managing governance, messaging, freezing smart contracts, triggering a dispute, self-help dispute resolution, if possible modify or terminate, and arbitration.

### Governance

The present invention contemplates a fully customizable governance protocol for managing access and rights within a smart contract. The invention provides a GUI that allows the contract creator to set which parties can access the smart contract and the level of rights each party may have. Level of access may vary from full access (same level as the contract creator) to view only and anywhere in between as it relates to each SDK feature disclosed. Access can be managed at contract creation, during the active phase, and after a contract has been signed.

### Messaging

The present invention further provides for a messaging system within a blockchain. All communication to users including contract monitoring (as discussed above) are performed using the messaging system. The messaging system is implemented as a DApp. Contracting parties may message each other within the blockchain in which messages are transmitted and stored as state or as a log event. In one embodiment, messages are implemented as state. The messages may be encrypted based on public keys of the recipient so that only the intended recipient may read the message. In an alternative embodiment, messages are implemented as log events. Log events are transmitted listing the message as well as the intended recipient(s). Messages can also be encrypted. This embodiment functions similar to the state approach with the exception that, recipients can receive notifications of incoming messages through standard node software using an event filter. In both embodiments the messaging system functions with the contract monitoring system, as discussed above. When a message is sent to the blockchain, the contract monitoring system (via a filter or precondition) will recognize that an activity of interest has occurred and notify the corresponding party via a message to an external network so they can respond in kind. In yet another embodiment, messages may be implemented as a separate messaging contract.

Alternatively, messaging can be implemented outside of the blockchain as part of a centralized system or conventional system as is known in the art. In this implementation, the messages can optionally be stored and recorded as part of the contract records.

### Freeze Contract

The freeze contract feature allows users to set conditions to freeze a smart contract from executing. The SDK provides users with preset options that would be commonly used such as prior to any transfer to funds, the contract is frozen until there is a command to execute from an authorized party. The freeze feature could be designed such that there are thresholds for larger amounts that would require authorization while smaller amounts would not. Additionally, the freeze contract, feature could be triggered by a contracting party with the correct level of access rights. Additionally, the contract can be set to only executing with explicit instruction from an authorized party. In some embodiments, a third party to the contract could be designed to trigger the execution based on their determination or any number of factors defined by the parties. When a contract is frozen, the system shuts off most of the external access ports so that the contract cannot execute.

### Delayed Execution

Alternatively/additionally, the contract could be set with a timed delay wherein the contract will notify the parties that it is going, to execute and give the parties a set amount of time to act before the contract executes. At this time the parties may wish to manually trigger a contract freeze.

### Trigger Dispute

In addition to the freeze contract feature, the SDK provides for an option for authorized parties to trigger a dispute. Once a dispute is triggered, the system checks whether the contract is frozen, if it is not, the system freezes the contract and then notifies the other parties that a dispute has been triggered so that they parties may communicate to resolve the dispute or issue.

### Dispute Resolution Self Help

After a dispute has been triggered and the parties notified, the system provides a messaging platform (as disclosed above) where the parties may communicate over the blockchain to handle the situation by themselves via negotiation and communication. Alternatively and additionally, there may be automatic rules set for handling certain types of disputes. The system may optionally provide programmed rules for handling disputes that are common.

### Contract Modification

In one embodiment of the invention the parties may modify their smart contract as part of the dispute resolution. The system allows the parties to propose and accept changes to an existing contract. The changes are recorded along with the original contract. If the parties are able to agree on the terms of the modified contract. The system then records the new contract and proxy call address of the contract such that it points to the address of the new contract.

### Dispute Resolution/Arbitration Marketplace

If the parties are unable to resolve their dispute, the parties my advance their issue to the dispute resolution marketplace. In one embodiment, the parties select a preferred arbitration platform at the time of contracting. In other embodiments, the parties may select arbitration from a marketplace at the time of the dispute. During the entire process of contract formation, contract freeze, dispute trigger, and dispute resolution self help, the process has been recorded by the system. At the time of arbitration, the system may package the entire dispute history in a format that is easy for a human arbitrator to read or based on certain requirements of arbitration standards. Once the arbitration has been resolved, the system will execute to carry out the judgement by either transferring the funds, only transferring a portion of the funds and returning the balance, or returning the full amount. Additionally, the judgement may be recorded as part of the smart contract records. As discussed above in the Dispute Resolution Self Help section, there may be automatic rules set for handling certain types of disputes. The system may optionally provide programmed rules for handling disputes that are common. For instance, if the system is implemented in a rental space and a property owner cancels the automated system would be able to recognize this situation and automatically resolve the dispute based on preset rules such as awarding full refund to the customer.

### BRIEF DESCRIPTION OF DRAWINGS

Preferred embodiments of the present invention are described with reference to the following drawings, wherein:

FIG. 1 depicts a contract management menu presented as a website listing active and archived contracts in accordance with an embodiment of the present invention;

FIG. 2 depicts a contract menu for a specific contract in accordance with an embodiment of the present invention;

FIG. 3 depicts a contract revision/notes menu wherein a contracting party can propose revisions to a contract and save a description for the notes;

FIG. 4 depicts a menu to change escrow for a contract in accordance with the present invention:,

FIG. 5 depicts a contract review menu wherein a user may accept and e-sign or reject and edit a proposed contract in accordance with an embodiment of the present invention;

FIG. 6 depicts an escrow review menu wherein a user may accept and e-sign or reject and edit a proposed escrow in accordance with an embodiment of the present invention;

FIG. 7 depicts an escrow transfer menu wherein a user may deposit an amount into escrow in accordance with an embodiment of the present invention;

FIG. 8 depicts network diagram of the contract management system in accordance with an embodiment of the present invention;

FIG. 9 depicts the process of creating a contract in accordance with an embodiment of the present invention;

FIG. 10 depicts a software development kit including smart contract in accordance with an embodiment of the present invention;

FIG. 11 depicts a software development kit implementing proxy call to a smart contract in accordance with another embodiment of the present invention.

FIG. 12 depicts the process of amending a contract in accordance with an embodiment of the present invention;

FIG. 13 depicts network diagram of contract monitoring system in accordance with an embodiment of the present invention;

FIG. 14 depicts the process for monitoring contracts in accordance with an embodiment of the present invention.

### DETAILED DESCRIPTION OF THE INVENTION

The system and method of the invention for managing a smart contract can be deployed in numerous systems including distributed ledgers, directed acyclic graph, centralized systems, and various different types of blockchains (public or private) or hybrid systems.

The present invention provides users with a system and method for creating and managing smart contracts on a blockchain. More specifically, the invention relates to a method and system that provides a set of tools for users to create, monitor, manage, modify, terminate, trigger disputes, communicate with contracting parties, and if necessary arbitrate the smart contract. These tools are presented to the user with a friendly and easy to use graphical user interface (GUI) so that the user does not need to know how to program smart contracts or have understanding of blockchain to realize benefits of blockchain technology. For example, in an embodiment of the present invention, the system utilizes a website to present user with GUI to create and manage a contract with escrow online. One benefit of this system over existing systems is that the contracts are implemented as smart contracts with escrow which is significantly cheaper to implement than traditional escrow services. Furthermore, the smart contract is stored in a blockchain which provides a trusted immutable ledger that can be trusted by all the contracting parties and is more resilient to hacks and tampering than traditional centralized server type systems. Additionally, the system also provides a software development kit (SDK) for users to create and program their own smart contracts while still taking advantage of the contract management components of the system.

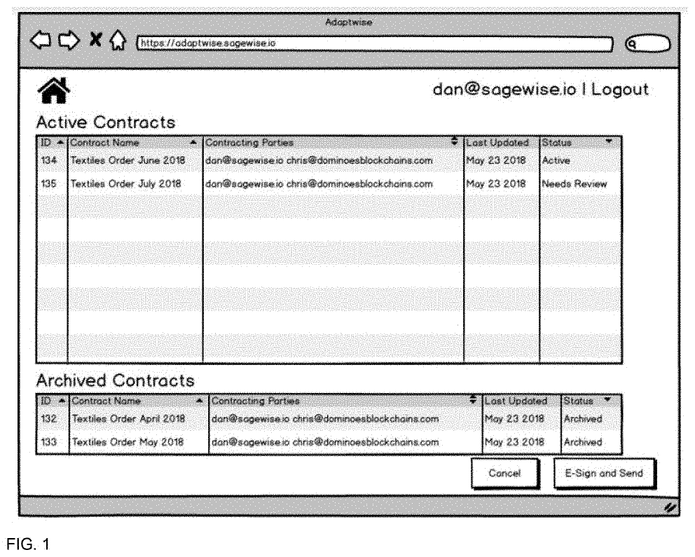

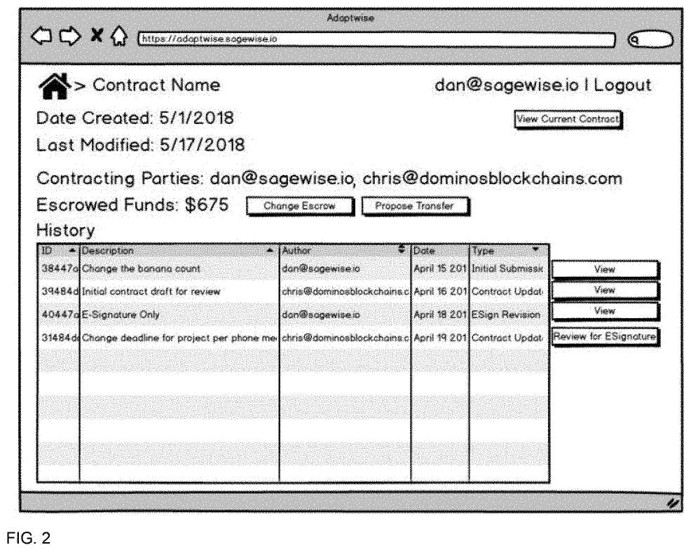

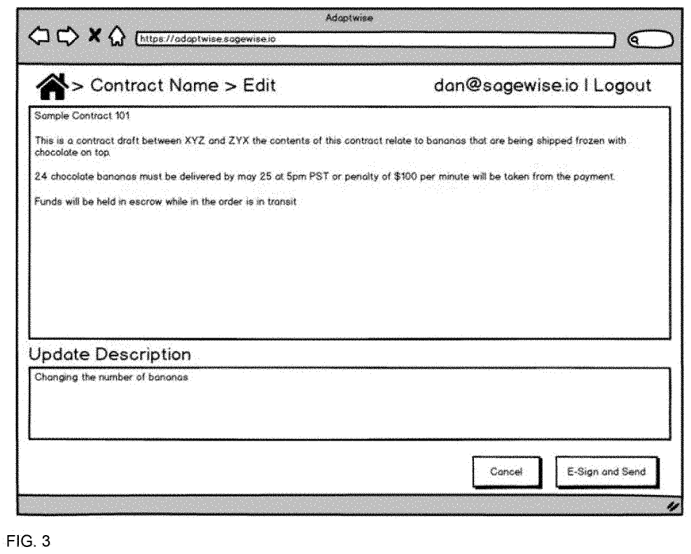

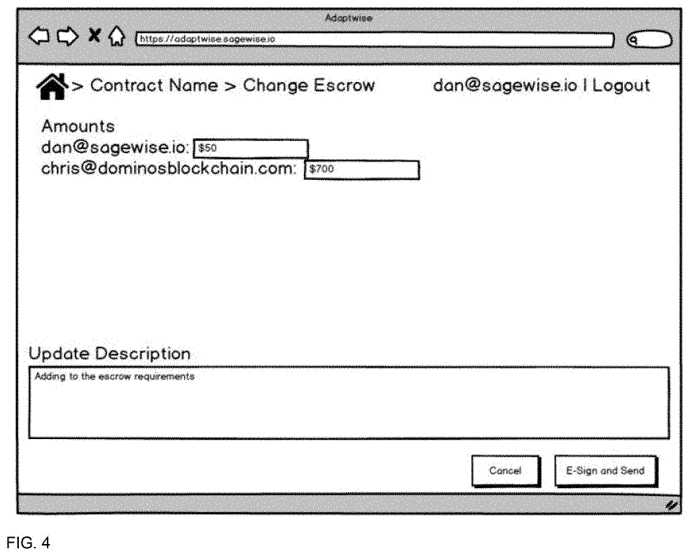

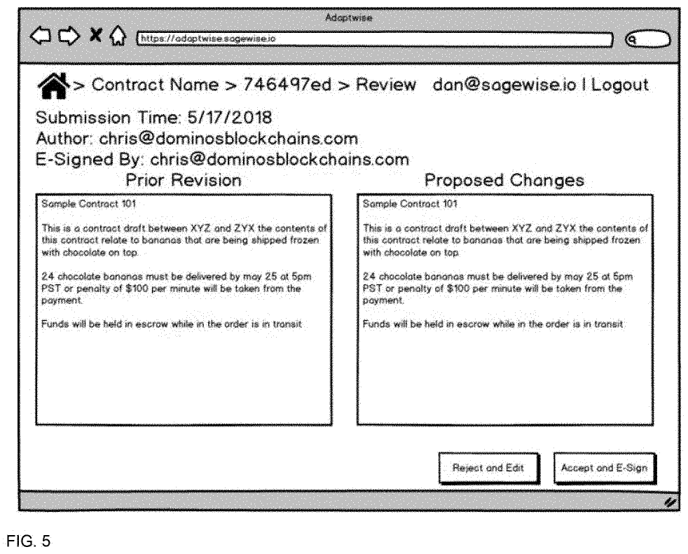

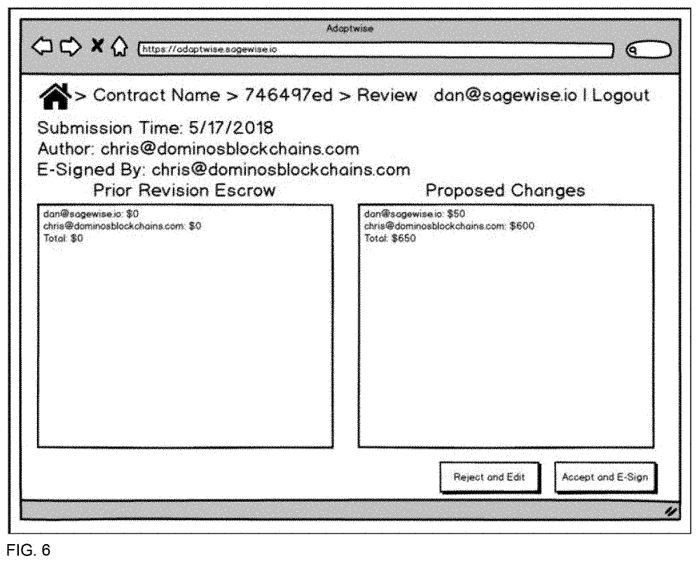

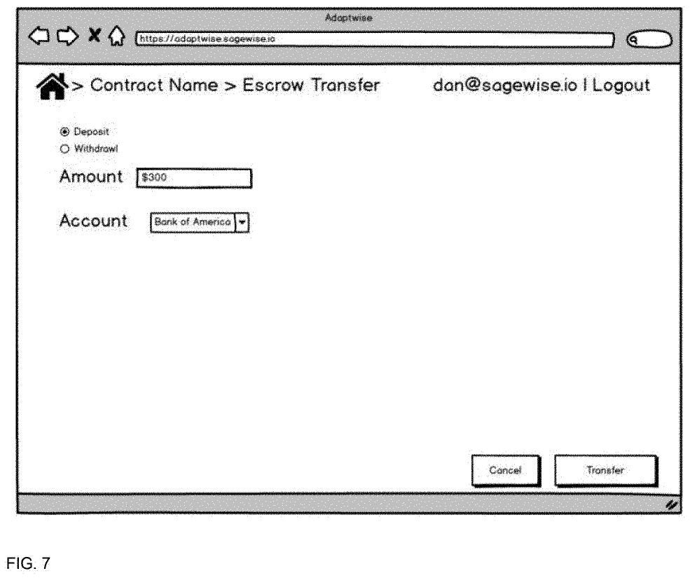

FIGS. 1-7 depict a smart contract creation and management system of the present invention embodied in a website. The system automatically provides the user with all the benefits of a distributed ledger and smart contracts discussed above without the user having to know anything about these features. The user simply has to progress through the system using the GUI to create and manage their contracts. FIG. 1 depicts a main page 1 listing a user's active and archived contracts (2 and 3, respectively). Active contracts are contracts that have not been signed yet. The main page 1 also provides an easy to use e-sign and send button 4 that automatically sends the active contract to the other contracting parties for execution. The contracts may be listed with additional information identifying/describing the contract including but not limited to: ID, contract name, contracting parties, creation date, last update date, status, whether contract has escrow, contract amount. FIG. 2 depicts a contract information page 5 screen that can be accessed after a user selects (or double clicks) a contract from the main page 1. The contract information page 5 provides further information regarding the selected contract including contract history 6 which lists the history of the contract including but not limited to: revisions, signature, updates, and change notes. Each item in the history is stored as part of the contract and has its own unique history ID 7. FIG. 3 depicts a contract edit page 8 which allows the user to make revisions on an existing contract or propose new terms. The user may also make a note on what is changed in the update description section 9. FIG. 4 depicts a escrow edit page 10 which allows the user to edit the escrow for the contract. FIG. 5 depicts a contract review page 11 which allows the user to view a contract. If there are revisions on the contract, the contract review page 11 will display the prior version with the proposed changes. While not depicted in the figures, in one embodiment of the invention, revisions are presented as redlines or “track changes” in which additions are underlined and deletions have a strikethrough. These allow the other contracting party to easily see what revisions were made. Further still in another embodiment of the present invention, when a user views a contract in a view contract page (not depicted) the user has an option of viewing the final contract with or without redlines. The user may accept the proposed changes or reject and propose their own edits by selecting the corresponding button at the bottom. Similarly FIG. 6 depicts an escrow review page 12 which provides the same options for the escrow. FIG. 7 depicts an escrow transfer page 13 which allows the user to select a bank account to transfer funds into escrow.

Alternatively, the system can be implemented as an API so that other developers and companies can use the novel invention and adapt it to their own processes/GUIs. The API would interact with the central server and system as discussed in greater detail below.

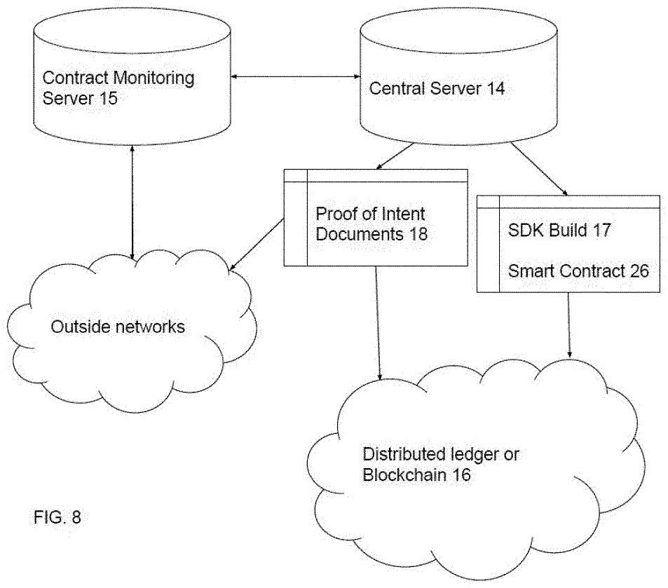

FIG. 8 depicts a network diagram of the contract management system in accordance with an embodiment of the present invention. In the depicted embodiment, the contract management system is implemented as website stored in a central server 14. In another embodiment, the contract management system is implemented as a DApp in a decentralized file storage (not depicted). In still another embodiment, the contract management system is implemented with an API. The central server 14 stores the web/mobile logic required to implement the system described above, and will be described in greater detail below. The central server 14 communicates with a contract monitoring server 15 to provide notification to contracting parties. In another embodiment, the contract monitoring server 15 is implemented as part, of the central server 14. The contract monitoring server 15 interacts with various external standard web and mobile infrastructures (outside networks) to communicate with contracting parties and dispute resolution vendors. Additionally, the central server 14 further comprises an SDK Build 17 which comprises at least two components: blockchain/ledger specific shared library and SDK tools package. In alternative embodiments, the SDK Build 17 can be presented to users independent of the central server 14 so that users can program their own contracts without the aid of the web/app based contract creation system. The central server 14 and contract monitoring server 15 interact with a distributed ledger or blockchain 16 to record, monitor, amend, and interact with smart contracts stored on the distributed ledger or blockchain 16 as discussed in greater detail below.

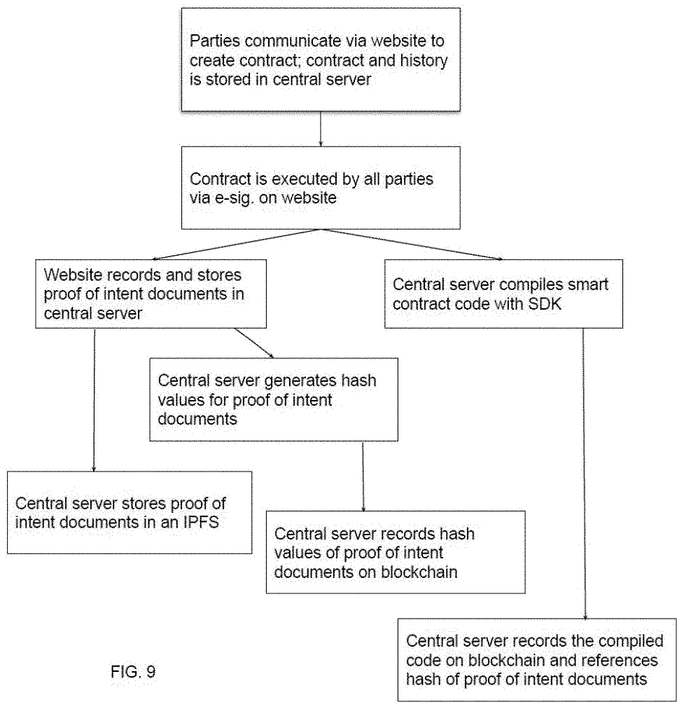

FIG. 9 depicts the process of creating a contract in accordance with an embodiment of the present invention. The contract creation process is handled by the central server 14 (or in alternative embodiments, a decentralized server via DApp). As the users interact with the contract creation system through the website as depicted in FIGS. 1-7, the central server 14 records all of the interaction history of the parties including but not limited to: basic information about the contract including terms, parties, dates, signatures, dispute resolution vendor, human readable text contract, prior versions of human readable text contract, notes made by contracting parties, smart contract code (prior to compiling). Once the parties have completed a contract by having all parties to the contract sign, the central server 14 compiles the interaction history into a set of proof of intent documents 18. Additionally, these documents are stored chronologically. The central server hashes the documents (separately or collectively) and publishes the hash(es) to the blockchain 16. If there are numerous documents, they may be separately hashed and reference prior documents (based on chronological order) using, a merkle tree. The central server 14 then stores the proof of intent documents 18 on an decentralized file storage where they can be accessed using their hash values. Alternatively, the proof of intent documents 18 may be stored in a central server and instead of storing hash values on the blockchain 16, links to the proof of intent documents 18 can be recorded on the blockchain 16. After the central server 14 has recorded the proof of intent documents 18 on the blockchain, the central server 14 also records the user's configuration settings and compiles the contract code with the SDK. The central server 14 then records the compiled contract code to the blockchain 16 and references the proof of intent documents 18. By recording the proof of intent documents 18 before the contract code, the system is able to organize and store the contract history and documentary evidence of the parties' intent as part of the final signed smart contract.

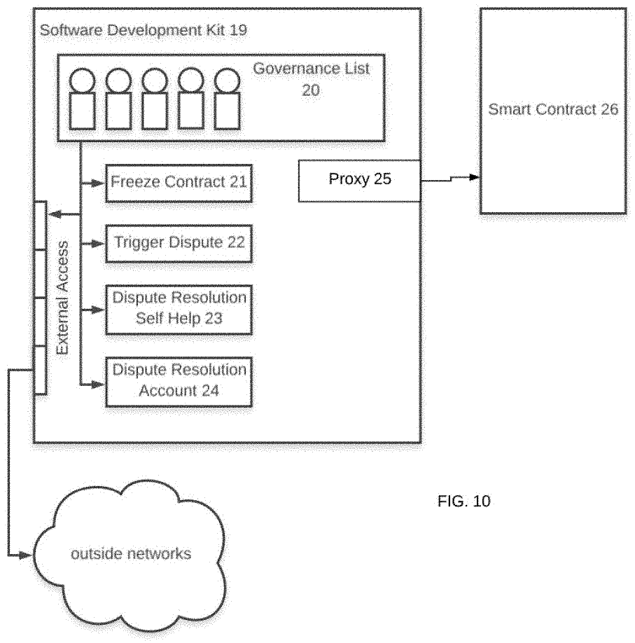

FIG. 10 depicts a smart contract implemented as part of an SDK 19 in accordance with one embodiment of the present invention. The smart contract of the present invention comprises at least the following features:
a hash—function that maps data of arbitrary size to data of a fixed size, this could include hash of prior versions of a contract or other reference documents pertaining to the contract, that the parties wish to link with the contract;
state—governance list, current status of contract (whether it is frozen or not) language, governance control parameters, dispute resolution vendor, whether self resolution is enabled or not, delayed transaction records, contract specific dispute resolution workflow (which could vary from contract to contract), contract upgrade proxy address, freeze mode toggle;
executable code—software code that can be run by the computer;
logs/events—signals that smart contracts can fire which can be received by external applications that have configured listeners;
public entry point/external access points—code points at which control is passed to the program from an external source;
SDK—will be discussed in greater detail below. In sum, it comprises code for managing governance, freezing, contract, triggering, a dispute, dispute resolution self help, and dispute resolution/arbitration platform.

SDK 19—depicted in FIG. 10 provides users with contract configuration features such as a governance list 20 (for managing access rights to the contract), freeze contract 21, trigger dispute 22, dispute resolution self help 23, and dispute resolution 24. These features and their configurations are selected by the users' during the initial contracting phase. For instance, regarding, the governance list 20, the contracting parties may set themselves as part of the governance list 20, additionally, they may also add an administrator or additional parties to the contract and can set varying levels of access and rights such as: full access, monitor only, etc. Additionally, if the parties choose a dispute resolution vendor, the dispute resolution vendor will be added to the governance list 20 with full access rights. This way if there is, a dispute and the dispute resolution vendor is able to resolve the issue, they would have access rights to amend and modify the contract as necessary to conform with their decision. Alternatively, the dispute resolution vendor may have limited access rights depending on the type of arbitration selected or preference of the contracting parties. In this embodiment, the smart contract code is compiled and stored separately on the blockchain 16. The SDK 19 is coded with a proxy call function that points to the location of the separately recorded smart contract 26. This allows for subsequent changes/amendments to the content of the smart contract to be done quickly by simply changing the proxy address to that of a new smart contract.

Below are exemplary sections of pseudo code for certain SDK components in accordance with an embodiment of the present invention:

Proof of Intent Code
Iterate through context documents

Hash current document, store result.

Send current document to file storage

Write document hash and filestore location to blockchain
Create master hash of all document hashes
Publish compiled contract to network, reference master hash

Dispute Mode Activation
Dispute activation mode function called
If the user is authorized to start dispute mode and has enough weight to cross threshold

Start dispute resolution mode (freeze public functions)

Start clock on self resolution timeout.
Else if user is authorized but does not have enough weight

Add user's weight to cumulative weight threshold

Self Resolution
DR party follows proof-of-intent process to create self resolution proposal contract
DR party submits self-resolution proposal with a contract address and function
Other approved DR participants vote yes or no on proposal
if(vote unanimous yes)

code is executed
else

end self dispute mode

enable dispute resolution vendor access

Governance
Smart contract publish transaction pushes constructor code to network
Constructor code runs which defines the initial list of members for the dispute activation list and threshold parameters for altering the list
Request is made to add or remove member of dispute activation list
Does requesting user have the needed permission level to perform action?

Add/remove user

Messaging
Sending
Merge message text, and conversation ID into blob
Use receiver public key to encrypt blob
Send encrypted blob to network with receiver address
Receiving
Query blockchain for list of messages sent to public address
Filter messages received prior
Iterate over messages one by one

Does sender match expected sender list
Decrypt message
Does conversation ID match known conversation?
   Display message

Freeze Contract
Contract dispute and freeze function called
If DRMode variable is false

Set DRMode variable to true

Delay Execution
Delay
Transaction delay called
Store transaction sender and deferred action with unique ID
Send after delay
Deferred send called with unique ID
Does transaction sender match record and expiration delay time elapsed?

Send action

Clear deferred transaction from state

Trigger Dispute
Contract dispute and freeze function called
If DRMode variable is false

Set DRMode variable to true

Dispute Resolution Self Help
DRMode initiator publishes new smart contract with self resolution code
DRMode initiator submits proposal transaction to use self resolution code to original smart contract
If all DRMode participants vote yes

Transaction processed
Else

Self resolution mode ended

Dispute resolution vendor given resolution access

Contract Modification
New contract published to network
Contract switch code published to network
Contract switch code address sent as delegate call to main, smart contract
Contract calls switch code address which changes the proxy address in local state

Dispute Resolution/Arbitration Marketplace
Selected dispute resolution vendor follows personal protocol to handle dispute
When completed, dispute resolution vendor submits new enforcement contract to network
Dispute resolution vendor calls admin function with enforcement contract address as parameter
Enforcement contract runs
Dispute resolution mode is disabled

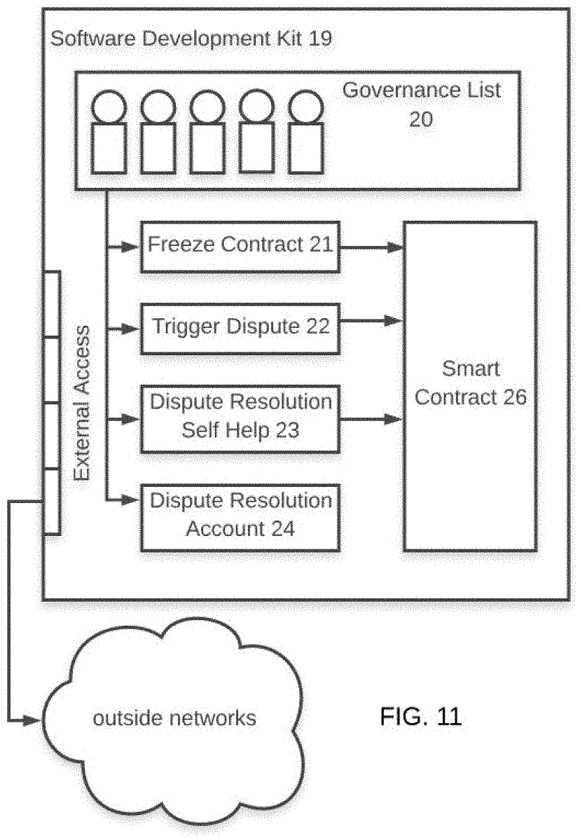

Alternatively, in another embodiment depicted in FIG. 11, the smart contract 26 and SDK 19 can be compiled and stored together. In this embodiment, the smart contract freeze function is programmed as an if/then statement to check the smart contract's “state” as either DRModetrue or DRModefalse. If the DRMode is true, then the contract state is frozen and contract cannot execute until the state is changed. The benefit of this feature is that it minimizes on transaction costs if the blockchain requires payment for using proxy calls. When frozen, the executable code cannot be modified, but any arbitrary code can be executed in the context of the contract allowing a wide range of changes to state and value held in the contract.

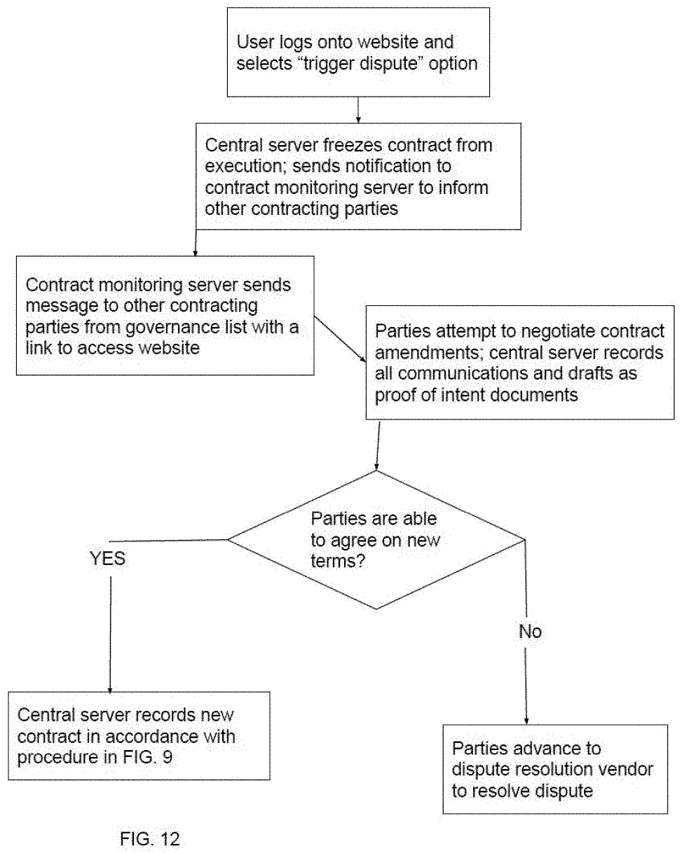

FIG. 12 depicts the process of amending a contract (that has already been signed and recorded on a blockchain 16) in accordance with an embodiment of the present invention. Contract amendments are handled in the system by the central server 14 and the contract monitoring server 15. In one embodiment, a user logs into the website and selects an option to amend, freeze, or trigger dispute for an archived contract 3. At this time, the central server 14 via the contract monitoring server 15 contacts the other parties listed on the governance list 20. The parties are given an opportunity to discuss amendments to the contract and come to an agreement on new terms via the messaging and dispute resolution self help 23. If the parties are able to agree on new contract terms after proposing amendments, all parties to the contract must sign the new contract. The central server 14 then records the amendment to the contract as a new contract (as discussed in FIG. 9) on the blockchain 16 and stores the parties' negotiation communications, revisions, original contract, and final contract as proof of intent documents 18.

In the embodiment of FIG. 10, wherein the SDK 19 is not compiled and stored with the smart contract 26, the new contract is simply compiled by the central server 14 and stored with hash of the proof of intent documents as a new contract. The central server 14 must also change the proxy call of the original SDK to reflect the address of the new smart contract.

In the embodiment of FIG. 11, wherein the SDK 19 is compiled with the smart contract 26, the central server 14 terminates the original smart contract and compiles a completely new smart contract with SDK that references the previous smart contract.

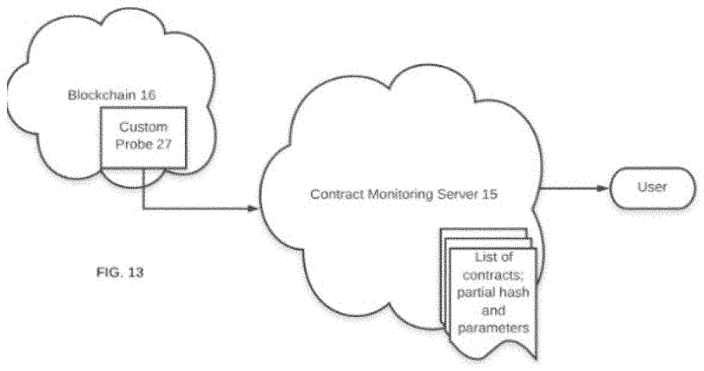

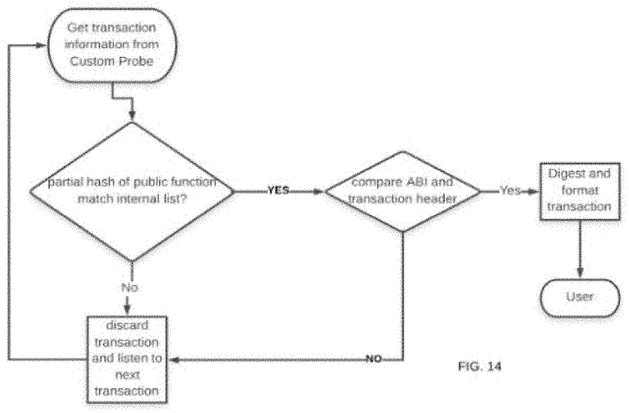

FIG. 13 depicts network diagram of contract monitoring system 15 in accordance with an embodiment of the present invention. The contract monitoring system 15 may be implemented as a separate or part of the central server 14. In this embodiment it is implemented as a separate server, contract monitoring server 15. Blockchain 16 systems are traditionally closed systems and do not many many interactions outside of the system unless it is specifically programmed to do so as part of the smart contract. Thus, there exists a need to create a system that can monitor the activity of a smart contract 26 within a blockchain 16. In order to monitor a smart contract 26 that is stored on a blockchain 16, a custom probe 27 is implemented in the blockchain 16 to monitor activity on the blockchain and report it to the contract monitoring, server 15. The contract monitoring server 15 contains a list of contract IDs, partial hash values, and various parameters (ABI and transaction headers, threshold values for certain transactions, etc.) set by the user based on their preferences. FIG. 14 depicts the process diagram of the contract monitoring server 15. First the contract monitoring server 15 gets transaction information from the custom probe 27 and determines whether it matches the hash of a public function from its internal list. While in this embodiment, partial hash values are monitored, other values such as contract ID can be monitored as well_{—} If the partial hash matches that of a partial hash stored in the contract monitoring server 15, the contract monitoring server 15 next compares the ABI and transaction headers to determine if there is a match. If there is no match, the contract monitoring server 15 discards the transaction and listens for the next one. However, if there is a match, the contract monitoring server 15 digests the transaction data and formats it and sends a notification to the relevant parties in the contract's governance list 20. Depending on the type of transaction and the rights of the parties, the parties may be required to take action. If further action is required, the notification can be sent with a link to the website on the central server 14 to take the necessary action such as resolving a dispute, approving a transaction, amending a contract, etc.

While the present invention has been described in terms of particular embodiments and applications, in both summarized and detailed forms, it is not intended that these descriptions in any way limit its scope to any such embodiments and applications, and it will be understood that many substitutions, changes and variations in the described embodiments, applications and details of the method and system illustrated herein and of their operation can be made by those skilled in the art without departing from the spirit of this invention.

1. A system for monitoring and reporting activity on a distributed ledger comprising:
a server comprising a first list of interested activities;
the server further comprising a means receiving data from a probe reporting activity on the distributed ledger;
the server further comprising means for determining whether a reported activity matches at least one item on each of the first list of interested activities;
the server further comprising a means for digesting the reported activity;
the server further comprising means for transmitting the digested reported activity.

2. The system of claim 1 wherein the distributed ledger system is a blockchain.

3. The system of claim 1 wherein the probe is stored on a distributed ledger node and reports all activity from the distributed ledger.

4. The system of claim 1 wherein the server further comprises a list of interested parties and the server transmitting the digested reported activity to the interested parties.

5. The system of claim 1 wherein the server transmits the digested reported activity to an outside network that is not the distributed ledger.

6. The system of claim 1 wherein the server transmits the digested reported activity to the distributed, ledger.

7. The system of claim 1 wherein the first list of interested activities comprises a list of at least one of the following:
smart contract address, partial hash of public function of smart contract, transaction header.

8. The system of claim 1 wherein the first list of interested activities comprises a list of at least one of the following:
application binary interface (ABI), threshold values for transaction information, contract state changes, code patterns, transaction patterns, external contract interactions, log messages, and SDK triggers.

9. A method of monitoring activity on a distributed ledger comprising:
a) receiving a report regarding an action occurring on the distributed ledger;
b) determining if the action satisfies a first condition, if it does not ignore action;
c) determining if the action satisfied a second condition, if it does not ignore action;
d) if the action satisfied both conditions, analyze the action and format the action information;
e) transmitting the formatted action information to a list of interested parties.

10. The method of claim 9 wherein the distributed ledger is a blockchain.

11. The method of claim 9 wherein the formatted action information is transmitted to an external network, not the distributed ledger.

12. The method of claim 9 wherein the formatted action information is transmitted to interested parties via the distributed ledger.

13. The method of claim 9 wherein the first condition is one of the following:
a smart contract address, partial hash of public function of smart contract, and transaction header.

14. The method of claim 9 wherein the second condition is at least one of the following:
application binary interface (ABI), threshold values for transaction information, contract state changes, code patterns, transaction patterns, external contract interactions, log messages, and SDK triggers.

15. The method of claim 9 wherein the action is a smart contract execution.

16. The method, of claim 9 wherein the action is a smart contract that is about to execute, but has not yet executed.

17. The method of claim 16 further comprising:
f) receiving a message from an interested party to freeze the action.
g) sending a message to the blockchain to change the state of the smart contract's action.

18. The system of claim 1 wherein the server further comprising a second list of interested activities and the means for determining also determines whether the reported activity satisfies at least one item on a second list of interested activities before it can digest a reported activity.
